(19) United States
(12) Patent Application Publication
(10) Pub. No.: US 2011/0307414 A1
(43) Pub. Date: Dec. 15, 2011

(54) Consensus Investment Analysis/Stock Selection Methodology

(76) Inventor: HANS P. HANSEN, GARWOOD, NJ (US)

(21) Appl. No.: 13/151,745

(22) Filed: Jun. 2, 2011

Related U.S. Application Data
(60) Provisional application No. 61/353,285, filed on Jun. 10, 2010.

(51) Int. Cl. G06Q 40/00

(52) U.S. Cl. 705/36 R

(57) ABSTRACT

A computer system for predicting investment performance trends is disclosed. The computer system has a data organizing module capable of organizing an investment data into at least one list. Furthermore the computer system has a data comparator module that is capable of sorting data into performance categories within at least one said list to arrive at a consistent top set. Further disclosed is a computer-enabled method of arriving at consistent investment performance set having the steps of obtaining an investment pricing list; organizing an investment data into lists; comparing investment assertions within said lists against said pricing list; sorting said investment data by a performance category; determining the best performing investment within said list; and isolating a consistently performing investment combination.

### PRIORITY

This application claims priority to U.S. provisional application Ser. No. 61/353,285 which was filed on Jun. 10, 2010, and the contents of which is incorporated herein by reference in its entirety.

### FIELD OF THE INVENTION

The invention relates to a computer system and a computer-enabled method for isolating and tracking a top performing combination of indicators and methods used to find investments.

### BACKGROUND OF THE INVENTION

The invention relates to a computer system that is capable of isolating and tracking investment opportunities, in particular, tracking publicly traded securities, based on a period of market performance coupled with a positive consensus among an array of sources specializing in investment analysis. The system is also able to collect and organize a variety of analysis data and display it in a condensed streamlined format. A combination of investments which illicit positive results are tracked over time in a controlled attempt to forecast future results. Tracking may be done over a certain period of time based on averages of pre-recorded results. Preferably, the value of the tracked investments is determined daily against a public quote or price list. Additionally, the computer system may provide a wrapper portal for accessing existing investment analysis and trading tools while augmenting these with its own displays and formats for presenting the investment data. The stock selection methodology is enabled through the operation of the computer system.

A small or unsophisticated investor, or one who has not developed an elaborate scheme of portfolio management, generally finds it difficult to make wise investment decisions despite having access to a variety of professional investment opinions. The difficulty stems from the general lack of consensus among investment analysts and financial analysis tools, as well as from a general absence of any clearly superior approach or strategy. While all analyses are based on a common value system, each financial analysis tool emphasizes its own particular bias. It is therefore difficult to determine which analyses method may be superior to others.

The present invention provides a useful, concrete and practical result of making investment decisions easier by finding clear winning investment strategies and by recognizing consensus among professional advisers. The computer system that enables the present invention may discover the best short term investment based solely on a superior performance history or solely on a common favorable opinion among investment advisors. Preferably however, these two factors are combined to select only the choices with the greatest potential of a positive return from the multitude of available investment choices.

Additionally, the present invention may also be able to compare the performance of any currently created data with any data created in the past. For example the data from June 5^{th} from American Bulls may be compared to data from June 4^{th} or another date, from American Bulls or against any other analyzer. Any date may be compared against any other date and different analyzers may be compared with each other. Each such comparison may be compared based on comparison criteria that may be set by the user; for example, a bullish outlook or bearish outlook. Results of any individual comparison action may be stored in a results record, which may again be a database or individualized files. A user may perform such comparisons for a period of several days, preferably ten days. At any time, the data within data records or results records may be further compared based on additional user defined criteria.

The present invention is also capable of keeping track of any investment choice that meets a user's criteria and which has received a similar recommendation by at least two analyzers. However, it should be noted, that a user would still be permitted to select and track performance of any investment, even those that do not meet the criteria set by the user and by the overall inventive concept. However, it is preferable that a user selects only those symbols that both meet the criteria and have a consensus, since these investments generally bode well for a portfolio versus investments that do not have all the desirable qualities. The selected symbols may be further tracked using the same download and average methodology.

The present invention may be used as a periodic tool to build or update one's investment portfolio. The present invention may also be very suitable for day trading operations by assisting a trader with selecting investment options to trade for that day. The methodology of using the present invention would be the same in either usage style. In both cases, a user may select a set of criteria and a time period for a comparison. Any investment choice that meets a desirable set of criteria along with a consensus from analyzers may be selected for trading by a user.

Various implements are known in the art, but fail to address the entire problem solved by the invention described herein. One embodiment of this invention is illustrated in the accompanying drawings and will be described in more detail herein below.

### SUMMARY OF THE INVENTION

The present invention discloses a computer system for predicting investment performance trends. The computer system has a data organizing module, which is capable of organizing an investment data into at least one list. Furthermore the computer system has a data comparator module that is capable of sorting data into performance categories within at least one said list to arrive at a consistent top set. Further disclosed is a computer-enabled method of arriving at consistent investment performance set having the steps of obtaining an investment pricing list; organizing an investment data into lists; comparing investment assertions within said lists against said pricing list; sorting said investment data by a performance category; determining the best performing investment within said list; and isolating a consistently performing investment combination.

The present invention is a computer system and a computer-enabled method that may be based on client server architecture or an in-proc (self contained) architecture. The client section of the architecture may be responsible for the front end user environment which has many useful and novel features, while the server section of the architecture may be responsible for obtaining the financial data, storing it, performing analytical calculations with it, and for storing results in an organized, controllable fashion. The server end of the present invention may also function as a central hub for multiple clients utilizing the present invention, which may or may not perform market analysis in concert with each other.

It is an object of the present computer system to provide an investment tool for selecting a winning combination of investment choices.

It is another object of the present invention to provide an investment forecasting tool that requires minimal knowledge or experience in selecting investments.

It is still another object of the present invention to provide a tool for selecting investments pursuant to a common investment assertion by two or more investment analyzers.

It is still another object of the present invention to provide a computer-enabled method for selecting investments based on prior market performance or based on a consensus of investment assertions of two or more investment analyzers.

Yet another object of the present invention is to provide a computer-enabled method of narrowing down a potential pool of promising investments.

Still another object of the present invention is to provide a computerized tool for predicting investment performance for the upcoming day.

Yet another object of the present invention is to provide a portal wrapper for automating access to multiple professional investment advisement resources.

### BRIEF DESCRIPTION OF THE DRAWINGS

FIG. 1 is a flow chart of the software that enables the present invention.

FIG. 2 is a flow chart of the software within a computer hardware topology.

FIG. 3 is an embodiment of the software and hardware components utilized by the present invention.

FIG. 4 is another screenshot showing a selection of the better performing lists of symbols and pair wise combinations of lists.

FIG. 4a is a screenshot of a table of market data that was downloaded for various market data analysis websites.

FIG. 5 is a screenshot showing a client screen for a particular trading day, and displaying the percentage of favorable, unfavorable and unchanged value of potential investment options.

FIGS. 6-8 are flow-charts describing the computer-enabled method disclosed in this invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

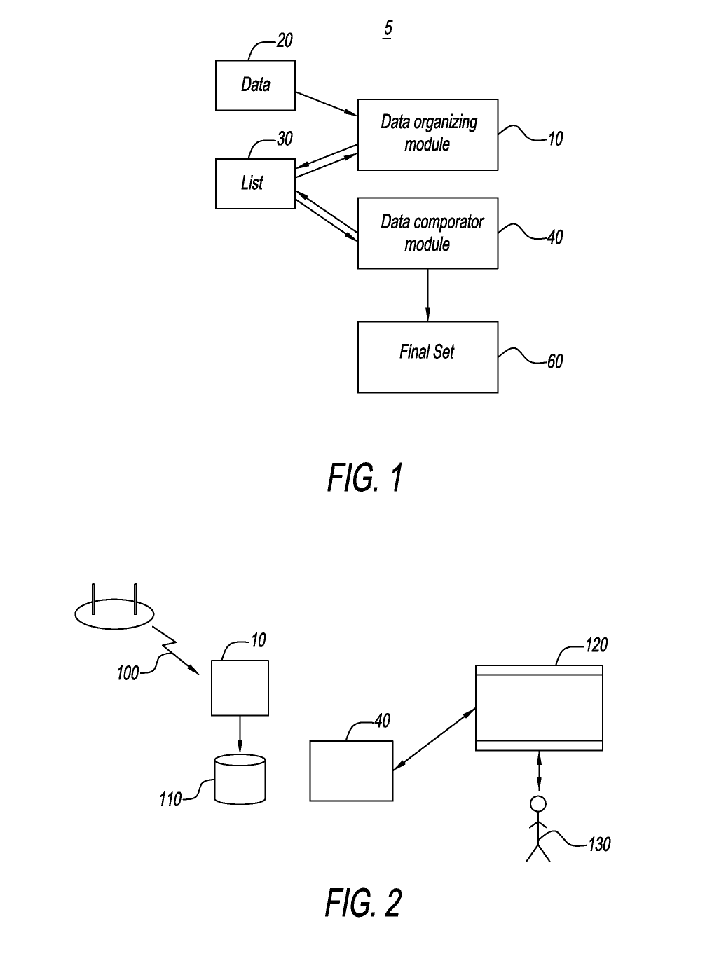

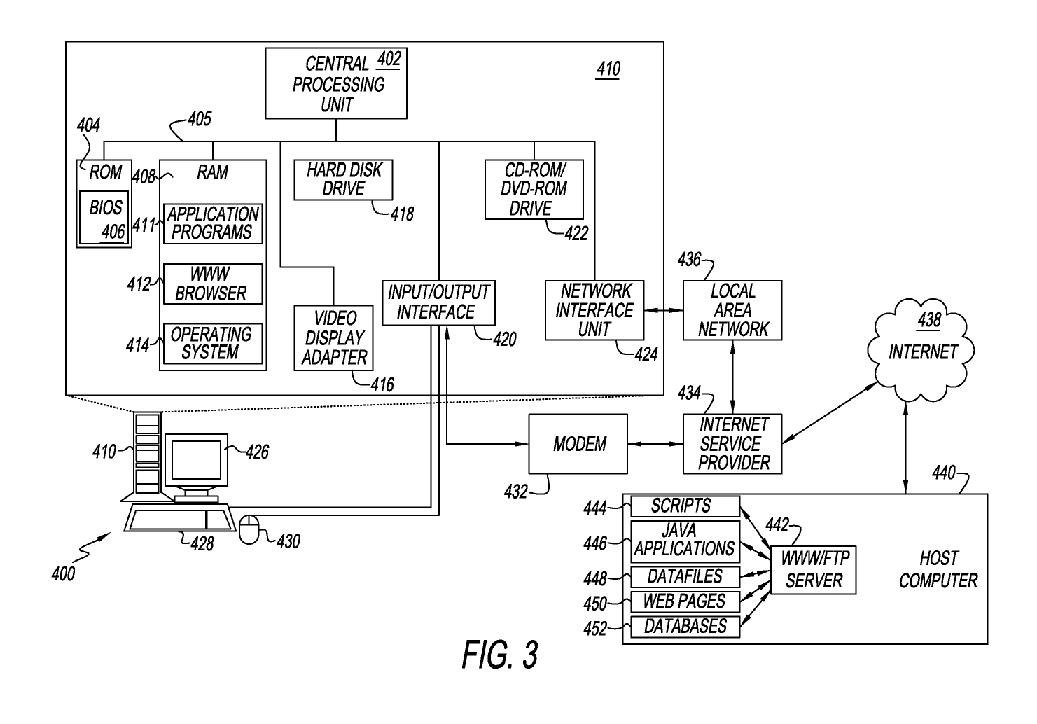

Referring now to FIGS. 1 and 2, shown are a computer system 5, a data organizing module 10, data 20, lists 30, a data comparator module 40, a network feed 100, a database 110, an input/output screen or a client or a client screen 120, and a user input 130. The computer system 5 may be based on client server architecture or may be entirely embodied in a self-contained application. The data comparator module 40 and the data organizing module 10 may also be collectively referred to as the business logic of the present invention. The modules 40 and 10 may be of a single homogeneous purpose or made from an amalgamation of services, modules, interfaces, plug-ins, or classes, or any other subunits common in the art. The terms data comparator module 40 and the data organizing module 10 extend to the entire process of feeding raw investment data into input portals of the computer system 5, to be transformed according to the methods described herein into a format that satisfies the spirit of the present invention, namely to select the best performing indicators based on prior history or based on a favorable selection by at least two financial analyzers.

The financial analyzers within scope of the present invention include individuals or companies that provide return on investment forecasting information, and in general that engage in the art of complex financial analysis. The opinions of the financial analyzers may be quantified or collected into data that is then processed by the present invention. The data may be entered by individual investment choice or as an array or a list of choices that may be specific or diverse and vast. The data preferably includes investments that have received favorable reviews by the originating analyzers, but may also include those investments that were unfavorably rated. Any electronic or manual means of distributing this data may be used, such as, but not limited to a direct upload or download feed over the internet 438, which may be enabled over a web link or directly between two servers connected locally or over the internet 438, or their proxies. The data feed may also be in the form of a file transfer protocol, a WCF service, or an HTTP based protocol, or any other data exchange protocol commonly used to transfer data electronically.

The analyzers come to their conclusions using a set of mathematical tools, familiarity with a particular market movement, a means of synthesizing relevant public information, and a set of emphasis or bias criteria that each analyzer prefers over other criteria. Using these tools the analyzers arrive at predictions or forecasts on which investments are likely to go up in value, and which may go down. In general, different analyzers or analysis companies may end up having different recommendations and different up and down prognostications. However, at times, analyzers may agree regarding individual investments or groups of investments. The agreement may arise from the use of similar or different analysis methodologies. This agreement is referred to in the claims as the pair wise combination and is premised on the idea that a conclusion is more likely or more meritorious when it is arrived at by at least two analyzers. The present invention contains business logic that seeks out such pair wise combinations and tries to capitalize on them by tracking the performance of investments that were recommended through a pair wise combination.

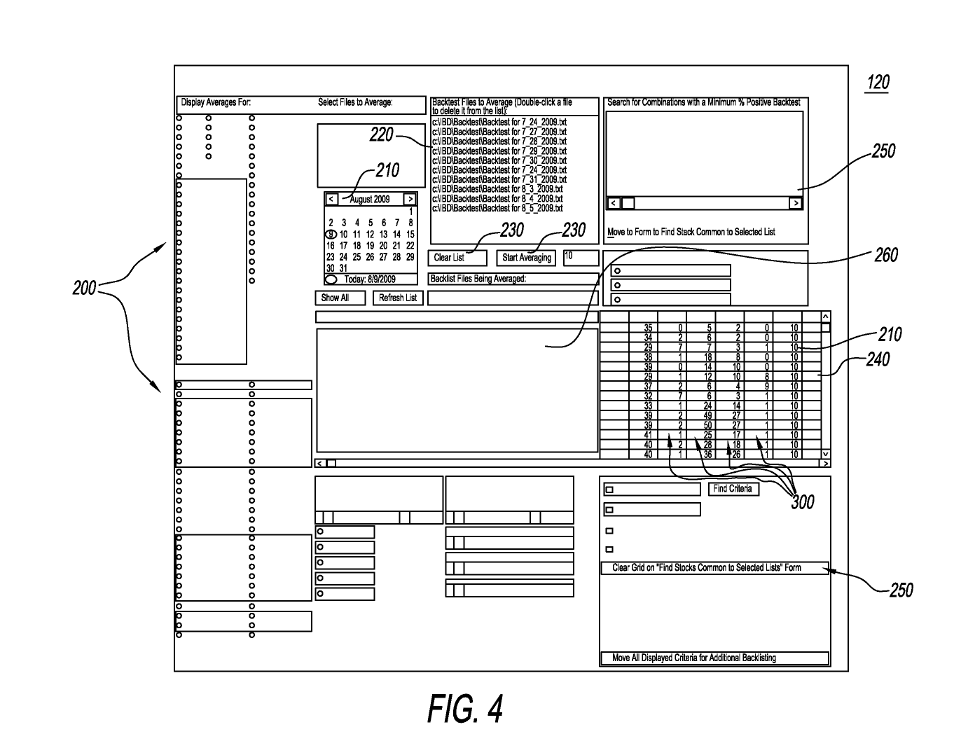

The computer system 5 may have a database 110, the data comparator module 40 and the data organizing module 10, which constitute the preferred software portion of the present invention. It is preferable to install these components on separate hardware units for modularity and scalability; however a single hardware unit may be utilized as well for any combination of the software components of the computer system 5. Multiple hardware units would necessarily involve some form of networking, such as, but not limited to Optical fiber, Ethernet, or a Wireless LAN. Connectivity may also be between the main computer or server and a front end graphical user interface (GUI) or client. The connectivity may be laid out in any manner, such as, but not limited to a bus network, star network, ring network, mesh network, star-bus network, tree or hierarchical topology network. Additionally the database 110 and the computer system 5 may be stored on separate systems and be connected over the same network or a different network, such as a storage area network (SAN). The preferred embodiment of the computer system 5 may be where the data comparator module 40 and the data organizer module 10 are installed and running on a single computer, such as a server or a personal computer, such as shown in FIG. 3.

Any networking present in an embodiment of the present invention must be one that furthers the spirit of the present invention, such as external communication over the internet 438, between the client 120 and the business logic modules 10 and 40, and the database 110. Other embodiments of the computer system 5 may be possible without departing from the spirit of the present invention, as can be appreciated by those skilled in the art.

The hardware unit being referred to here is a central processing unit (CPU) 402 (FIG. 3) that is disposed in its own computer or as a logical slice of a large, multi CPU 402 server. Alternatively, the computer system 5 may be entirely installed on a single CPU 402 architecture or any other configuration that permits sufficient computational bandwidth required for an embodiment of the present invention.

A computer system 5 may be a stand alone bundle of computer code and may include all of the necessary instructions, system calls and libraries to be able to manipulate hardware resources, such as hard disk drives 418, or random access memory (RAM) 408, or operating system resources 414. Alternatively, the computer system 5 may be written within an application server, such as, but not limited to Red Hat Jboss, Oracle Weblogic, or IBM Websphere. In such an embodiment the computer system 5 may contain business logic necessary to enable the data comparator module 40 and the data organizing module 10, while all of the standard hardware and inter-process calls are handled by the application server.

The client 120 may be designated to be the presentation layer of the computer system 5. The client 120 may be written in any language, such as, but not limited to Java, C/C++, C#,

Ruby, Perl, Python, Visual Basic, as well as their parent languages or any dialects influenced by these languages. The client 120 may communicate with the data comparator module 40 or the data organizing module 10 using a remote procedure call (RPC), or Java's remote method invocation (RMI), or Microsoft's .Net Remoting, or within a framework of Windows Communication Foundation (WCF), or any other publisher and subscriber or listener framework. Any particular approach may be dependant on a hardware platform, overall environment, or backwards compatibility considerations. In another embodiment the client 120 may be rendered on a user's hand held remote device, such as a cell phone, a pocket computer or a pocket organizer. There may be multiple clients 120 connected over the internet 438 or local network into a common computer system 5. In such an embodiment, the computer system 5 may have a separate authentication or proxy module for system and access security, or this security level may be implemented within the existing business logic modules 10 and 40.

The client 120, the data comparator module 40, or the data organizing module 10 may be written, or compiled for any operating system 414. A particular operating system 414 may be different or the same between the different components of the present invention. For example, the client 120 may compiled to run in Windows Vista or Windows 7, while the business logic may be compiled to run on a UNIX or a Linux platform.

In another embodiment, the computer system 5 may be entirely rendered on a user's device, such as a personal computer 400 on FIG. 3, a handheld computer (not shown), or any other input and display device, such as a phone or a personal data organizer (PDA). The technology of the client 120 and the business logic modules may be merged or kept separate, depending on the deployment architecture that takes into account a particular application of the present invention.

In yet another embodiment the client 120 may be launched from anywhere using a web browser, such as but not limited to, Internet Explorer, Firefox, Netscape or Mozilla. A user would generally access a specific address (web site) on the Internet 438 by entering a uniform resource locator (URL) of the web site into an appropriate location on the browser, or the address may be preset or preconfigured to be accessed automatically within an application. The entry would consist of a computer address and a string instruction that is then forwarded over the Internet 438 to the computer address, where the string instruction is then interpreted by a web server on the addressed computer. The string instruction may be contained within a standard common customer gateway (CGI) syntax.

In a web page embodiment, the client 120 may be written in any language that can render an image in a web browser, coupled with a technological ability to render interactive web pages, or web pages that are capable of receiving and responding to input from a user. The preferred client 120 would be capable to render interactive web pages so as to record any authentication information and to absorb user instructions on which lists to sample and which investment choices to track. A typical web page is rendered in a markup language that a web browser is able to interpret such as HTML or XML or any other markup language capable of rendering an appropriately styled and sized web page. An interactive web page may additionally have a separate interactive content rendered using cascading style sheets (CSS), or in a high level language such as AJAX, ColdFusion, Perl, JavaScript or Ruby. Alternatively, the entire webpage may be rendered in a cascading style sheet that may be written in a high level language.

The data organizing module (DOM) 10 may preferably manage the acquisition of the data 20. The data 20 may preferably be obtained from a third party, such as, but not limited to, a financial analyzer, a pricing or a valuation expert, a source of news, or any other third party that disseminates investment choice recommendations. DOM 10 may receive data 20 from an analyzer at random intervals, as requested, or pursuant to a subscription agreement. The data 20 may preferably include a list of values or a quote list for all investment choices included in the data 20. Preferably, all supplied investment choices may then be valued against the downloaded quote list, to determine the precise value of each investment. The DOM 10 may then store the evaluated investment choices in a database 110 or as separate lists 30, or in a database of lists. The lists 30 may be sorted by source, performance, price, industry, or investment type, or based on any other factor. Preferably, however, the data is written to text files or to comma separated files. Such storage is preferable since the data comparator module 40 works by comparing entire lists against each other or against a price list. Therefore, storage within a commercial database may likely involve a database query, a parsing of a response to a query, and a list compilation based on this response. Therefore, by storing all the investment data in a list, one likely economizes on several intermediary data manipulation steps. Preferably, the lists 30 are sorted according to the originator or the analyzer of the data 20 that is contained within these lists 30. The lists 30 may preferably be sorted according to a time period during which data was obtained, or according to any other criteria that would identify one type of data from another. To minimize disk space and RAM requirements, DOM 10 preferably loads and processes the data 20 at the end of a business day, when all valuations have been finalized.

Alternatively the database 110 may be a commercially available database package that may be capable of storing investment choices in separate records or in a record list. The same or different database 110 may be used to store an investment valuation data, an originator of the investment choice data, or other factor describing the data in an organized and easily accessible fashion. Preferably the database 110 may be capable of keeping track of records using a data dictionary. Furthermore, a database 110 should preferably maintain a failure recovery medium to preserve transactions in an event of failure, crash or transaction cancellations. The examples of commercial databases include, but are not limited to Oracle Rdbms, Sybase ASE, IBM DB2, as well as Informix and MySql. Other databases may be possible, even a simple comma or whitespace separated file lists may be used as a record storage medium.

The particular way in which the business logic modules 10 and 40 interact with a database 110 may likely depend on a particular embodiment of the computer system 5. In general, every high level computer language, as well as any application server, contains its own application programming interface (API) with instructions, libraries and sub-routines that enable a seamless communication with any type of a database used. For example, open database connectivity (ODBC) provides a standard by which many languages may connect to a database. Some languages provide proprietary wrappers for ODBC, such as Java's JDBC Bridge for ODBC. In the present invention, the client 120 may be able to communication with the database 110 or may do so through interaction with the business logic modules 10 and 40.

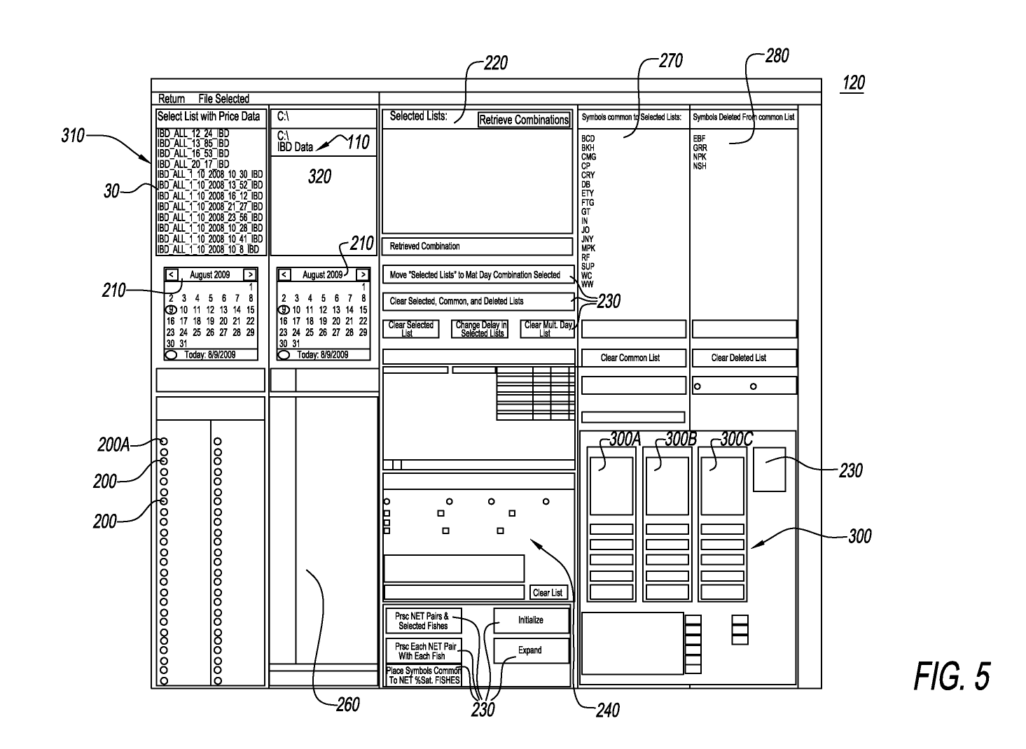

Preferably DOM 10 obtains a data 20 from the analyzers or from another source during a particular performance time period. Subsequently, a valuation list of investments within the data 20 may be done continuously, or on some other schedule such as, but not limited to, daily and preferably at the end of a business day. DOM 10, may then assign a value for each investment choice within the data 20, on a daily basis, according to the valuation obtained that day, for a performance period specified by default or set by a user 130. Each such investment valuation may be written to a separate list 260 for that day and preferably grouped by a sorting convention adopted for, and based on a particular performance time period. Therefore, on any given day during a performance period, multiple lists 260 may be created, or a single list 260 may be created that may be delimited by date and another sorting criteria, such as the originating analyzer. Preferably however, the lists 260 (FIG. 5) are created separately and sorted by the analyzing source and data or time of compilation. In another alternative, all investment choices are stored directly within a database as separate records or records having a unique primary key, and which may be preferably linked by a common characteristic, such as by analyzer and date of compilation.

Thus, for example, an analyzer known as VectorVest® may suggest on December 1^{st} that investment choices “A”, “B”, “C” and “D” may increase in value. Another analyzer, for example, American Bulls® may suggest on December 1^{st}, that the investment choices “A”, “B”, “E” and “F” may increase. These recommendations are fed into the computer system 5 as data 20. The DOM module 10 would also load market values or prices for all investments currently traded by a particular market, which necessarily includes the investment choices “A, B, C, D, E and F”. Investment choices “A, B, C, D, E and F” may then be appropriately valued and stored within at least one list 260 written for that particular day. There may be at least two lists 260, one for each analyzer, or a single list 260 that encompasses both analyzers that are distinguishable from each other by internal data formatting conventions.

The next day, December 2^{nd}, DOM 10 may again receive a valuation list and assign this list to the investment choices received on December 1^{st}. The valuation from December 2^{nd} may preferably be stored in a separate set of lists 260 assigned to December 2^{nd}, or in a single list 260 or a database 110 and distinguished by an internal date recording conventions. If a selected performance time period is ten days, this valuation and recordation by DOM 10 may continue for 10 days, which may be trading days. The performance time period may be a period of at least two days for which, and based on which, a data sample is taken. The data sample may be subset of each data 20 and represents a percentage of investments that have gone up in value, the percentage of investments that have gone down in value and any that remained unchanged. Additionally, DOM 10 may maintain a statistical record that may tally the average performance of each investment choice within the lists 260, or for overall performance of each list 260 over the ten day period or any other period. The DOM 10 may also continuously record recommendation data 20 each day. The statistics may be stored in a separate list 260, may be added to an ongoing collection of lists 260 or may be stored as a record in a database 110 or within a particular list 30 that is under immediate analysis by the computer system 5. Each day's list may be used for a current or a different tracking analysis. Separate analysis efforts or threads may be run simultaneously and distinguished with a database by record type or recorded in different lists 30 and accessed by the same or different screen view within the clients 120.

The data comparator module (DCM) 40 accesses the database 110 containing the lists 260 or a database 110 that may be comprised of the lists 260, all of which were prepared by the data organizer module 10. The DCM 40 operates in accordance to the input from a user 130 that is recorded via the client 120. The user 130 may specify the date for which lists 260 are to be compared and the performance time period. The user 130 may also specify which lists 260 or a combination of lists should be compared with each other to determine pair wise combinations and a best resulting performance across the lists that may included in a pair wise combination. The DCM 40 may compare lists 260 from the same analyzer or different analyzers together to determine the percentage of investments rising or dropping in value.

In the example above a user 130 may utilize the client 120 to select December 1^{st} as the benchmark date or the beginning date for this analysis and tracking scenario. In another example, both VectorVest® and American Bulls® send DOM 10 a set of data 20 containing investment choices that have dropped in value or that may have increased in value, namely, “G, H, I, J” and “G, H, K, L”, respectively. On December 2^{nd}, a user 130 may review the lists 260 and sort them by performance category, which may preferably be comprised of the number of investment choices going up, the number or percentage of investments rising, dropping, or remaining unchanged.

The user 130 may also compare each list 260 according to each analyzer, and check for common investment choices. For example the list 260 containing “A, B, C, and D” may be compared against “A, B, E, and F”. Thus, this comparison would be considered a pair wise combination between a list 30 from VectorVest® (VV) versus a list 30 of American Bulls® (AB). The combination of these two lists 260 results in another list 30. The DCM 40 may now track the resulting list 260 based on the overall percentage of rising investment choices within both lists 260, or only track the pair wise combination choices “A” and “B”. In another scenario the DCM 40 may track symbols that not part of a pair wise combination, for example in our case symbols “C, D, E and F”. Additionally, if the user 130 sees that the combination of VV and AB is ineffective, he or she may choose to combine VV or BB against a different analyzer or combine all three or more together. If for example, the percentage of rising choices is too great to serve as an effective measure for a precise valuation forecast. Thus, adding a third or fourth analyzer list 260 may likely reduce the resulting set of rising choices, and enable the user 130 to make more focused and precise investment decisions. The performance categories and averages may be stored in a separate list 260 or database 110.

The DCM 40 may contain logic that would try to avoid null sets. For example, a combining a VV recommended list of choices and a VV list of unfavorable choices would produce a null set, since no symbol in the first list is reasonably expected to appear in the second list. Alternatively, the user 130 may have a choice to override the null set restriction. For example, the lists 260 may be combined to obtain a summary of the effectiveness of a particular analyzer.

The present invention may also be automated to perform the manual steps described above. For example, the DOM 10 may be automated to download data 20 at specific intervals from a particular list of analyzers or from some other source. The performance time period may be updated periodically or have a default value. The aim of the business logic of the present invention is to isolate a small set of the best and the most consistent investment choices or a consistent top set.

The business logic of the computer system 5 may also handle all inter-process calls or commands that are issued within the client 120. In the computer system 5 or the DOM 10 and DCM 40 combination may contain additional functionality for processing data entered through the client interface 120, for managing user access 130 into the client tier 120, and for managing access to data within the database 110.

The data 20 may come in a variety of formats, such as, but not limited to, pre-loaded data in a database or some form of storage media. Preferably the data 20 originates at a remote financial data dissemination source, such as a site that disseminates recommended lists investments either through a manual or automatic file transfer, such as FTP, or a real time downloads. The data 20 coming over a network feed 100, such as a global computer network (GCC or internet) 438, would preferably be split into frames based on a standard length of a TCP/IP packet or a packet of a different network protocol. Such a packet would preferably contain a pointer or indicator that would enable the data to be reconstructed at the destination computer by the operating system 414 of the present computer system 5.

FIG. 3 contains a further description of the hardware and software components that are contained in a machine that would enable the computer system 5. Therefore, FIG. 3 and the following discussion are intended to provide a brief, general description of a suitable computing environment in which the invention may be implemented. Referring now to FIG. 3, an illustrative environment for implementing the invention includes a conventional personal computer 400, including a processing unit 402, a system memory, including read only memory (ROM) 404 and random access memory (RAM) 408, and a system bus 405 that couples the system memory to the processing unit 402. The read only memory (ROM) 404 includes a basic input/output system 406 (BIOS), containing the basic routines that help to transfer information between elements within the personal computer 400, such as during start-up. The personal computer 400 further includes a hard disk drive 418 and an optical disk drive 422, e.g., for reading a CD-ROM disk or DVD disk, or to read from or write to other optical media. The drives and their associated computer-readable media provide nonvolatile storage for the personal computer 400. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 408, including an operating system 414 and one or more application programs 411, such as a program for browsing the world-wide-web, such as WWW browser 412. Such program modules may be stored on hard disk drive 418 and loaded into RAM 408 either partially or fully for execution.

A user may enter commands and information into the personal computer 400 through a keyboard 428 and pointing device, such as a mouse 430. Other control input devices (not shown) may include a microphone, joystick, game pad, satellite dish, scanner, or the like. These and other input devices are often connected to the processing unit 400 through an input/output interface 420 that is coupled to the system bus, but may be connected by other interfaces, such as a game port, universal serial bus, or firewire port. A display monitor 426 or other type of display device is also connected to the system bus 405 via an interface, such as a video display adapter 416. In addition to the monitor, personal computers typically include other peripheral output devices (not shown), such as speakers or printers. The personal computer 400 may be capable of displaying a graphical user interface on monitor 426.

The personal computer 400 may operate in a networked environment using logical connections to one or more remote computers, such as a host computer 440. The host computer 440 may be a server, a router, a peer device or other common network node, and typically includes many or all of the elements described relative to the personal computer 400. The LAN 436 may be further connected to a GCN service provider 434 (“ISP”) for access to the GCN 438. In this manner, WWW browser 412 may connect to host computer 440 through LAN 436, ISP 434, and the GCN 438. Such networking environments are commonplace in offices, enterprise-wide computer networks, intranets and the GCN.

When used in a LAN networking environment, the personal computer 400 is connected to the LAN 436 through a network interface unit 424. When used in a WAN networking environment, the personal computer 400 typically includes a modem 432 or other means for establishing communications through the GCN service provider 434 to the GCN. The modem 432, which may be internal or external, is connected to the system bus 405 via the input/output interface 420. It will be appreciated that the network connections shown are illustrative and other means of establishing a communications link between the computers may be used.

The operating system 414 generally controls the operation of the previously discussed personal computer 400, including input/output operations. In the illustrative operating environment, the invention is used in conjunction with Microsoft Corporation's “Windows 98” operating system and a WWW browser 412, such as Microsoft Corporation's GCN Explorer or Netscape Corporation's GCN Navigator, operating under this operating system. However, it should be understood that the invention can be implemented for use in other operating systems, such as Microsoft Corporation's “WINDOWS NT”,“WINDOWS 2000”,“WINDOWS XP”, “WINDOWS VISTA”, “WINDOWS 7” and various version of the “WINDOWS SERVER” operating systems, IBM Corporation's “OS/2” operating system, SunSoft's “SOLARIS” operating system used in workstations manufactured by Sun Microsystems, and the operating systems used in “MACINTOSH” computers manufactured by Apple Computer, Inc, as well as for any flavor of UNIX and Linux operating systems available. Likewise, the invention may be implemented for use with other WWW browsers known to those skilled in the art.

Host computer 440 is also connected to the GCN 438, and may contain components similar to those contained in personal computer 400 described above. Additionally, host computer 440 may execute an application program for receiving requests for WWW pages, and for serving such pages to the requestor, such as WWW server 442. According to an embodiment of the present invention, WWW server 442 may receive requests for WWW pages 450 or other documents from WWW browser 412. In response to these requests, WWW server 442 may transmit WWW pages 450 comprising hyper-text markup language (“HTML”) or other markup language files, such as active server pages, to WWW browser 412. Likewise, WWW server 442 may also transmit requested data files 448, such as graphical images or text information, to WWW browser 412. WWW server may also execute scripts 444, such as CGI or PERL scripts, to dynamically produce WWW pages 450 for transmission to WWW browser 412. WWW server 442 may also transmit scripts 444, such as a script written in JavaScript, to WWW browser 412 for execution. Similarly, WWW server 442 may transmit programs written in the Java programming language, developed by Sun Microsystems, Inc., to WWW browser 412 for execution. As will be described in more detail below, aspects of the present invention may be embodied in application programs executed by host computer 442, such as scripts 444, or may be embodied in application programs executed by computer 400, such as Java applications 446. Those skilled in the art will also appreciate that aspects of the invention may also be embodied in a stand-alone application program.

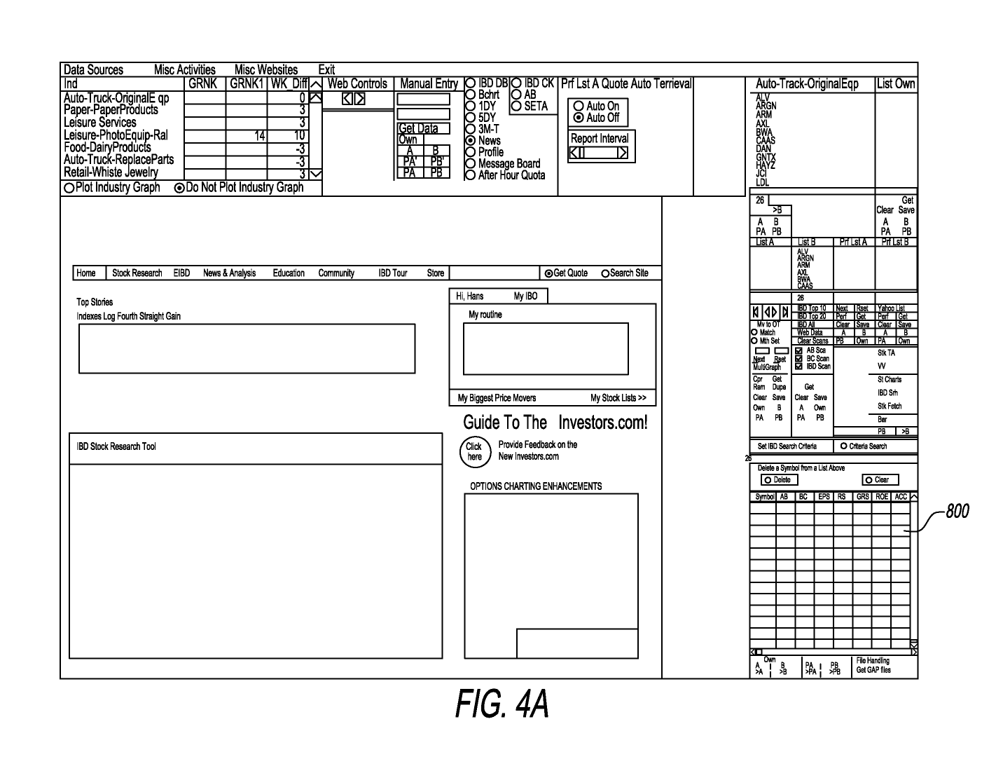

Referring now to FIGS. 4 and 5, shown is the client screen 120. Shown in FIG. 4 is an analyzer data 200, a performance time period widget 210, list 220 containing files from which a list of common symbols are derived (list 270), lists 30, action widgets 230, a pair wise combination comparison screen 240, and advanced narrowing criteria screens 250. Referring specifically to FIG. 5, shown are an analyzer data 200, a performance time period widget 210, an averaging screen 220, a plurality of lists 30, action widgets 230, a pair wise comparison screen 240, a comparison enhancement tool or a refinement tool 250, a screen of available lists 260, a common choice lists screen 270, a screen with differences 280, a performance criteria screen 300, an increasing criteria view 300A, a degreasing criteria view 300B, an unchanged criteria view 300C, a valuated list screen 310, lists 30, a database access screen 320, and a database 110.

The analyzer data 200 may be in form of raw data, as received from the analyzers, or it may already be stored with valuation and other factors in place. The data for each analyzer selection 200A may come from individual database records or individual lists or common records or a database of records or lists. Additionally, an individual selection 200A may refer to a single investment choice or a list of investment choices grouped by a common factor. Investment choices are preferably publicly traded securities. However, the term investment choices may also extend to dept instruments, option contracts, futures contracts, short term instruments, derivative instruments, or any other instruments, combinations, amalgamations and derivatives that are used to generate a rate of return on any type of invested capital. The present invention may also be used with non-securities investment choices, for example real estate holdings.

The location of the database 110 having investment choices or having lists 30 may be set to a default location or may be specified in the database access screen 320. In FIG. 5 the user 130 has drilled down to a comma separated database 110, to access lists of investment choices stored therein. The analyzer data screen 200 may be populated based on the contents of the database 110 or it may be constant or static, with values for some lists being null.

On FIG. 4, the performance time period widget 210 may be engaged to set a monitoring time period between two or more dates. The time period may be between some date in the past and the present date, or some period in the past, some period in the future, or a period that extends from the past until the future. The averaging screen 220 may show which of the lists 30 are being presently averaged by the DCM 40. The averaging may be done by DCM 40 either for each list 30 or for all lists that are present in the averaging screen.

An important feature of the present invention is the ability to compare recommendations between different analyzers. The simplest set of pair wise comparison may be based on two lists 30. The pair wise comparison screen 240 is shown comparing two lists from the same or different analyzers. Note that analyzers may be removed or added at any time during the comparison, to manipulate results and achieve the best possible combination of top performing investment choices. The pair wise comparison screen 240 may be expanded to display the performance characteristics 300 for each comparison set, as well as the performance time period 210, which may be the same or different for each set being compared. The comparison screen 240 is preferably disposed in a row of adjacent columns. Alternatively, the comparison screen 240 may be displayed either completely or partially, as a bar chart, a line chart or a pie chart.

A plurality of action widgets 230 may be used throughout the client interface 120 to perform a variety of tasks, such as, but not limited to triggering commands, transferring relevant data and for recording and reacting to user input. The widgets 230 are represented in the client 120 or the business logic modules 10 and 40 as a set of computer code that implements business logic to manipulate the data present within the lists 30 or the database 110. Typically the action widgets 230 trigger an event that may have a listener within the client 120 or the business logic modules 10 and 40. The action widgets 230 may also be used to configure the client 120, to automate some or all of the functions of the computer system 5 and to support any other ancillary or primary tasks necessary to enable the present invention.

By comparing two or more lists 260 together, the user 130 attempts a dual task of isolating consistently performing investment choices and for finding a small modicum of consensus among analyzers. These two factors tend to be associated with better investment choices and are sometimes mutually supporting. The aim is to obtain a set of preferably five to ten investment choices. At times, the consensus and performance isolate too few or too many investment choices, requiring that the comparison be refined or enhanced. Some of the comparison enhancement are shown in a refinement screen 270, and may include, but are not limited to a minimum or maximum percentage of increase or degrease of value, a range of days of rising or falling value, exclusionary or inclusionary conditions, or emphasis on a certain factor or condition, or any other refinement means that may be used by one skilled in the art for this purpose.

Illustrated in FIG. 4a is a table of market data that was downloaded for various market data analysis websites. The present invention is capable of forming a table 800. The table 800 is a quick way to determine the opinion of each analyst regarding a particular investment choice. Preferably, such a table would contain a symbol as a first column with various analysis websites as an overhead row. The last column of such table may contain a symbol or an investment rating. This may be an overall rating, a common rating, or a rating obtained from a widely accepted source. Another column may contain performance, valuation, as well as percentage of increase or decrease of this investment choice.

Turning back to FIG. 4, a user 130 utilizing the present invention, may receive a download of market data for a single stock symbol or multiple symbols from a number of market analysis websites (analyzers), such as, but not limited to American Bulls, VectorVest, Stock Tracker and StockTa, as well as any other websites performing investment performance analysis. Preferably a user must already have had a subscription or a connection to such analyzers. A login configuration screen may enable a user 130 of the present invention to add or remove analyzers, as well as to configure login information, address information any other requirements that are specific to each analyzer. Once an analyzer has been added a user may no longer need to re-login into any of the analyzer portals to receive updates from data 20 as all login information may be automatically sent to each analyzer by DOM 10 during access time. Once a connection is established the first time, the present invention may be able to handle all future data exchange correspondence between itself and user selected analyzers.

The present invention may be used as a tool to download information on an investment, such as a stock symbol, or any other type of investment choice, from all analyzers one by one or in a group. The symbols may also be grouped by criteria selected by a user; for example, by industry. The results for individual investments or investment groups may be placed into a chart 800 (FIG. 4a) with recommendations by each analyzer coupled with an overall score by an independent news reporting agency, such as the Investor Business Daily (IBD). The same chart may be implemented for both individual stock symbols and a group of stock symbols. All investment options may be grouped by industry or by different criteria, selected by a user of the present invention. The financial data must be downloaded at least once in a trading session, either based on intraday market activity or by end of day market activity. Once data is downloaded, it may be saved in a database and grouped within the present invention by analyzer, symbol, and type of data and date of the record. The data within the database 110 or the lists 260 may be retained for a later analysis or be discarded.

Referring now specifically to FIG. 5, the performance characteristics screen 300 provides a breakdown of investment choices in a single list 30 or in a compared list 30 that may be increasing or decreasing in value. The performance characteristics screen 300 may also provide a percentage of investment choices in each criterion. The top performance set may appear in the common choice list 270 when all comparisons have been performed over a performance time period. The common choice list 270 may also be used to display investment choices that are common to pair wise lists. The top performing set may or may not be the same or substantially similar to a pair wise set.

At any point during a performance time period, the user may refine the top set by adding or subtracting lists 220 from either the available list screen 220. The valued list screen 310 contains all lists of investment choices that have been assigned a value, both for the current day and for prior days. The available list screen 260 may contain lists 30 that are most relevant to the comparisons that are presently being performed. The relevance may be based on any number of factors, for example, the originating authorizer, industry, or investment type, such as, but not limited to a ten day moving average with percentage of stocks increasing in value

Although an embodiment of the client 120 has been described, any other embodiment of the client is also possible without detracting from the spirit of the invention.

Additionally, the present invention may also provide a portal into any analyzer with which a user has a subscription, account or connection. Therefore, a user may be able to select a symbol and view charts, trading statistics, ratings and any other data directly within analyzer websites, without having to log into each one. The data 20 may also be organized by the present invention to make a user's browsing experience more predictable and uniform; for example, by grouping together similar resources of otherwise competing analyzers.

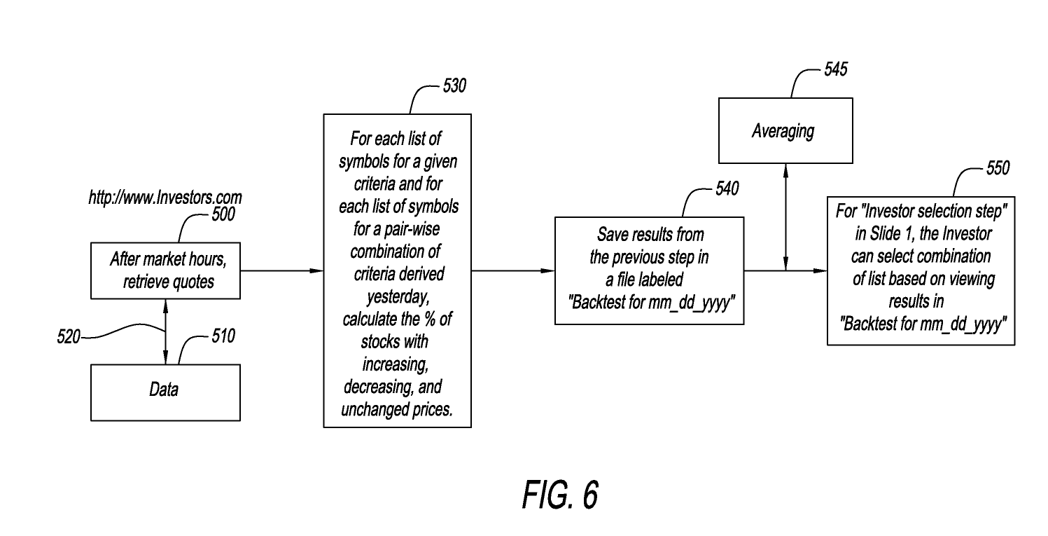

FIGS. 6-8 contain the discussion for the computer enabled method embodied in the present invention. The present invention aims to extrapolate the best performing investment choices over time, coupled with discovering of a consensus among financial analysts or other experts in the financial industry. The consensus may also be referred to as a common trend, at which different analyzers arrived using their individualized methodologies. It further follows, that the present invention aims to take advantage of a bullish investment choice that is supported by the good sense and experience of at least two analyzers.

Shown in FIG. 6 are some of the steps that make up the computer-enabled method of arriving at consistent investment performance set or a consistent top set. For the purposes of the present disclosure, the steps in FIGS. 6-8 may be explicitly stated in full at least once and then referred to as simply the step with an appropriate number that will be reflected in the figures. Shown in FIG. 6 are the steps of obtaining an investment pricing list 500, organizing an investment data into lists 510, comparing investment assertions within said lists against said pricing list 520, sorting said investment data by a performance category 530, data further analyzed over a predetermined period of time 540, averaging individual datum within said performance categories 545, and a step of determining the best performing investment within said list 550.

The step 500 may be accomplished in many different ways, for example, a pricing list or a valuation list may be provided to a user 130 on a magnetically or optically enabled medium that the user 130 may then install on his or her CPU 402. Preferably however, the valuation or price list may be downloaded electronically from a commercial pricing tool via the internet 438. The price list may be a list of quotes for securities type investments, or yields and maturities for dept type of investments, or prices and/or risk factors of short term or derivative type of investments. The pricing or valuation list referred to in step 500 may also be a market price of the investment choice within data, or any other type of valuation used in the industry.

The step of organizing an investment data into lists 510 preferably refers to accepting raw data and sorting it by the analyzer, date of arrival or compilation, type of investment choice, and according to factors relevant to the art of investing. After the data has been sorted by the business logic modules 10 and 40 into factors stated herein, the data 20 is then stored in the database 110, which may be files representing lists 30.

The step of comparing investment assertions within said lists against said pricing list 520 may occur simultaneously with step 510 or may occur separately. This may depend on the specific embodiment of the present invention or type of data 20. It may also depend on whether the user prefers the list 510 to be merged with the step 500, so that the investment choices within the lists 30 are always properly valued. The valuation or pricing may also occur at a later period; for example, at the steps of sorting said investment data by a performance category 530, data further analyzed over a predetermined period of time 540, averaging individual datum within said performance categories 545, and determining the best performing investment within said list 550.

The step of sorting said investment data by a performance category 530 may preferably refer to the process of determining which investment choices increase in value, which decrease and which remain unchanged. The valuation may take into account the pricing or valuation list loaded in step 500, which may be loaded daily, against the data organization step 510, which is preferably loaded periodically, or based on user preferences. The basic performance valuation may be described as comparing yesterday's or a prior date values of the investment choices against the present day values that are received in step 500.

The step wherein data is further analyzed over a predetermined period of time 540 may preferably refer to the period of time during which a user is tracking analyzer forecasts, to determine the best possible set of investment choices. The predetermined period of time may preferably be at ten days or less. However, this represents a variable term, which may be extended or shortened during the analysis period, as per user preference.

Still referring to FIG. 6, the step of averaging individual datum within said performance categories 545, may preferably refer to the taking average performance of each total list 30 (FIG. 1); each investment choice within each list 30 (FIG. 1); each investment choice of common investment choices that resulted from a pair wise combination by at least two analyzers or a pair-wise combination; or each total pair-wise combination. Any other averaging and statistical step may be included in the step 545. The step 545 includes other tools that aim in assisting users in zeroing in on the best possible set of investment choices, selected from the lists 30. The pair-wise or single lists valuations in step 530, as well as averaging and other refining and statistical techniques in step 545 are preferably carried out by the DCM 40 of the computer system 5.

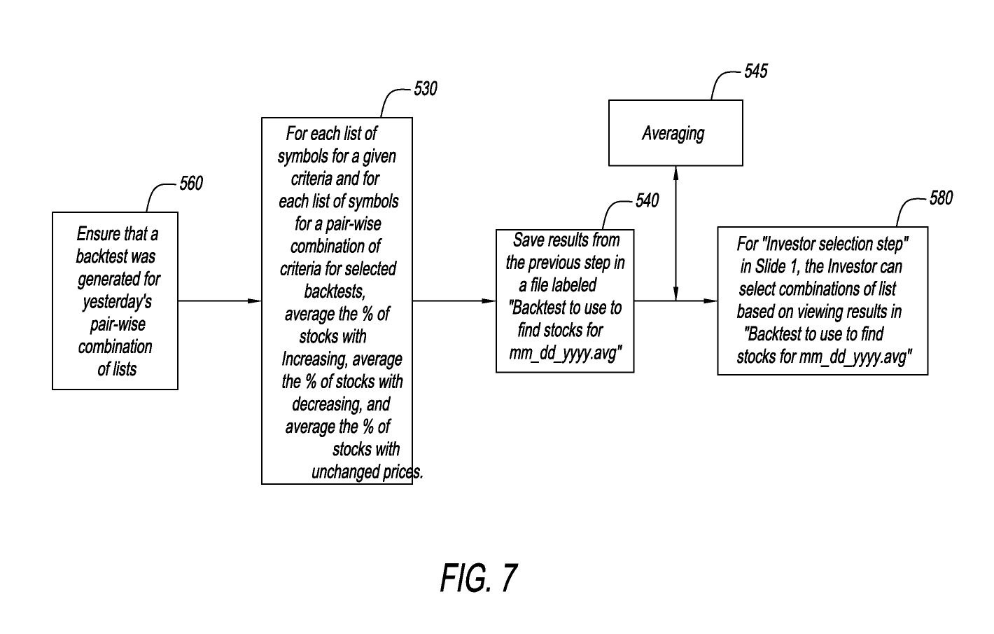

The steps shown in FIG. 6 may be done for each daily sampling, comparing and valuating of the investment choices within lists 30, and preferably leads to the step of determining the best performing investment within said list 550. Step 550 may additionally refer to an action of recording the best set based on analysis for that particular day, or based on the day's analysis that may compare today's performance characteristics 300 with any of the prior date or prior period results, which may be referred to as back testing. Ultimately, the step of isolating a consistently performing investment combination 580 (FIGS. 7 & 8) preferably refers to the step 545 as applied to the group of best performing investments 550, taken over a performance period 540 (FIG. 7), and which then results in a final and definitive top performing set in step 580, otherwise known as a consistent top set. This process is further described in FIG. 7.

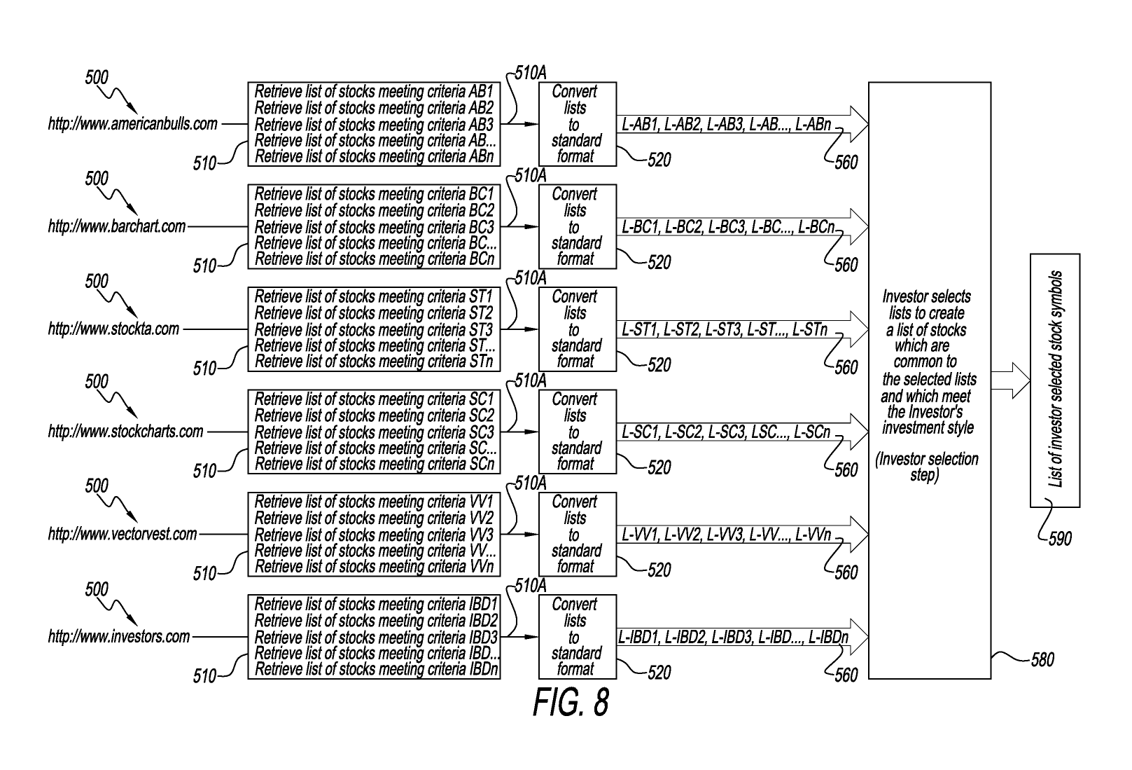

Referring now to FIG. 7, shown are the steps of forming a pair wise combination of at least two lists of investment data 560, sorting said investment data by a performance category 530, data further analyzed over a predetermined period of time 540, averaging individual datum within said performance categories 545, and the step of isolating a consistently performing investment combination 580, which results in a user selecting the most desirable list of investments in step 590 (FIG. 8). The step 560 may be a combination of a single set or a combination of sets that were arrived at in step 550. A pair wise combination analysis may be similarly performed for at least three or even at least five lists 30 or any number of lists 30; limited only by the bandwidth of the computing power of the CPU 402.

The step of forming a pair wise combination of at least two lists of investment data 560 may also refer to a single list 260 from one analyzer that is compared against that day's pricing list obtained in step 500. However, at this point, a user may have more than one list 260 to choose from, therefore comparing two or more analyzers or creating a pair wise combination may be preferable, since this may provide a greater likelihood that the superior performance of the commonly asserted investment choice is meritorious, and therefore more sustainable.

Preferably, the investment choices common to both lists 260 within the pair wise combination in step 560 may be selected for pair-wise and single lists valuations in step 530. The common choices are valued according to the pricing information received in step 500 and saved to another list 30 for that particular day, within the predetermined period of time of step 540 that may also be referred to as the performance period. Pair wise combinations of step 560 of subsequent days and for a predetermined period of time may now preferably utilize this new list 30 for pair wise and averaging analysis taken on later days within the predetermined period. However, since prior lists 30 (FIG. 1) may preferably not be discarded, the user 130 may use an original list 30 or a pair wise combination list compiled on any of the days, for any subsequent pair wise combination.

The steps described in FIGS. 6-8 may be executed manually by a user 130 through the client 120. However, the computer system 5 may be configured to automatically execute some or all of the stated steps. Either of the business logic modules DOM 10 or DCM 40 may contain automation functionality. Alternatively, a separate automation module may be included to handle automated execution and may consist of a group of subroutines, scripts, or batch files, or may be a separate application module that may be written in a high level language.

The analysis of the computer-enabled method may be enhanced or altered with data manipulation techniques. For example, the forming of a pair wise combination in step 560 may be further enhanced or modified by adding additional lists 30 to the pair wise combination being analyzed, by removing any lists from such a combination, or by substituting one of the lists 30 with another of the lists 30 from the combination. Additionally, the step of isolating a top performing investment assertion 580 may be further influenced by selecting different options in the advance narrowing criteria screens 250 of the client 120. Also, lists 30 may be compiled from different dates within step 540. The pair wise combination may by averaged within step 545 as discussed in FIG. 6, to arrive at a consistently performing investment combination 580, or for isolating the best performing investment assertion. Additionally, part of the pricing or valuation list retrieval or download in step 500 may be to obtain data 20 containing various common market benchmarks, such as, but not limited to a period of days moving average. The computer system 5 may be capable of selecting investment choices that outperform or that are the closely mimic the performance of the moving average. The moving average analysis may be preferably implemented by the DCM 40 or within steps 530, 540, 545 or 560 as described herein.

FIG. 8 is a summary of steps described in FIGS. 6 and 7. It is also an overview of the general aim of the present invention, where data from many analyzers may be grouped or otherwise manipulated, to arrive at a small subset of investment choices having the best potential to continue rising for the day or a period after the expiration of the predetermined period of tracking investment performances.

Shown in FIG. 8 are steps of obtaining an investment pricing list 500, organizing an investment data into lists 510, receiving said investment data from at least one source 510A, comparing investment assertions within said lists against said pricing list 520, forming a pair wise combination of at least two lists of investment data 560, isolating a consistently performing investment combination 580, which then results in a user selecting the most desirable list of investments in step 590. The investment choices obtained in step 590 may then be used for the immediate next day or a brief future period of trading.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A computer system for predicting investment performance trends comprising:
a data organizing module; said data organizing module capable of receiving an investment data and organizing the investment data into at least one list; and
a data comparator module; said data comparator module capable of sorting data into performance categories within at least one said list to arrive at a consistent top set.

2. The computer system of claim 1, wherein said data comparator module is capable of comparing at least two said lists based on a common investment assertions between said lists.

3. The computer system of claim 1, wherein said data comparator module is capable of comparing at least two said lists based on a performance time period.

4. The computer system of claim 1, wherein said data comparator module is capable of comparing at least two said lists based on common investment assertions between said at least two lists, and wherein said data comparator module is capable of testing for said common investment assertions based on a performance time period.

5. The computer system of claim 1, wherein said data comparator module is capable of comparing said performance categories against a moving average.

6. The data organizer module of claim 1, wherein said investment data is obtained from third parties, and where said data is sorted by source, attribute, criteria or any combination thereof.

7. The computer system of claim 2, wherein said data comparator module is capable of comparing at least 3 said lists.

8. The computer system of claim 2, wherein said data comparator module is capable of comparing at least 5 said lists.

9. A computer-enabled method of arriving at consistent investment performance set comprising the steps of:
a data organizing module obtaining an investment pricing list;
the data organizing module organizing an investment data into at least one list;
a comparator module comparing investment assertions within said lists against said pricing list;
the comparator module sorting said investment data by a performance category;
the comparator module determining the best performing investment within said list; and
isolating a consistently performing investment combination.

10. The computer-enabled method of claim 9, further comprising the steps of:
forming a pair wise combination of at least two lists of investment data such that performance of said investment data is determined according to a common investment assertion; and
isolating the best performing investment assertion.

11. The computer-enabled method of claim 9 further comprised of data organizing module receiving said investment data from at least one source.

12. The computer-enabled method of claim 11, further comprising the step of:
adding additional lists to said pair wise combination, wherein pair wise combinations are compared across all combined lists.

13. The computer-enabled method of claim 9, wherein the step of sorting said investment data is further analyzed over a predetermined period of time.

14. The computer-enabled method of claim 9, further comprising the step of averaging individual datum within said performance categories.

15. The computer-enabled method of claim 11, further comprising the step of removing said lists from said combination, wherein pair wise combinations are compared across all combined lists.

16. The computer-enabled method of claim 11, further comprising the step of substituting one of said lists with another of said lists from said combination, wherein pair wise combinations are compared across all combined lists.

17. The computer-enabled method of claim 11, wherein said lists are compiled on different dates.

18. The computer-enabled method of claim 12, further comprising the steps of:
of forming a pair wise combination of at least two lists of investment data such that performance of said investment data is determined according to a common investment assertion and said lists containing data from the same or different sources; and
isolating a top performing investment assertion;
